(19) United States
(12) Patent Application Publication
(10) Pub. No.: US 2022/0074896 A1
(43) Pub. Date: Mar. 10, 2022

(54) Apparatus and Method of Detecting Anomalies in an Acoustic Signal

(71) Applicant: Ping Services Pty Ltd, Adelaide (AU)

(72) Inventors: Matthew Stead, Adelaide (AU); Jon Cooper, Adelaide (AU)

(21) Appl. No.: 17/531,453

(22) Filed: Nov. 19, 2021

Related U.S. Application Data
(63) Continuation of application No. 17/050,390, filed on Oct. 23, 2020.

(30) Foreign Application Priority Data
Apr. 26, 2018 (AU) 2018901384

(51) Int. Cl. G01N 29/14; F03D 17/00; G01N 29/44

(52) U.S. Cl. CPC G01N 29/14; F03D 17/00; G01N 29/4445; F05B 2260/80; F05B 2270/81; F05B 2270/321; F05B 2270/333; F05B 2270/70; F05B 2270/32

(57) ABSTRACT

An apparatus for detecting anomalies in an acoustic signal, the apparatus including: one or more microphones for receiving an acoustic signal of an environment; and a processor implementing: an acoustic signal processing module configured to: analyse the acoustic signal to identify anomalies in the acoustic signal indicative of events occurring in the environment; and classify the anomalies in the acoustic signal into one or more event classifications; and a communications module configured to output the one or more event classifications, wherein the apparatus is located in the environment and includes an environmental enclosure arranged to house the processor and to protect the processor from environmental contaminants.

### TECHNICAL FIELD

The present invention relates to an apparatus and method of detecting anomalies in an acoustic signal. In particular, but not exclusively, the apparatus includes microphones for receiving an acoustic signal of an environment; and a processor configured to analyse the acoustic signal to identify anomalies indicative of events occurring in the environment and to classify the anomalies into one or more event classifications for output, wherein the apparatus is located in the environment and includes an environmental enclosure arranged to house the processor and to protect the processor from environmental contaminants.

In an example, a method using the apparatus includes the steps of: receiving the acoustic signal emitted during operation of wind turbines; analysing the acoustic signal to identify anomalies indicative of defects on the wind turbines; classifying the anomalies into defect classifications; and outputting the defect classifications to a third party associated with providing maintenance for the wind turbines.

### BACKGROUND OF INVENTION

Environments such as national parks, airports, constructions sites, mines and quarries, etc., are often harsh environments for equipment deploying to monitor the acoustic signal of the environment to detect anomalies occurring in the environment. Furthermore, this equipment may typically be moved between sites and not used continuously, but anomalies occurring in the environment may require immediate action.

One example of such an environment where constant monitoring is not typically employed is that of a wind farm. In a wind farm, wind turbines are used extensively to convert wind kinetic energy into electrical energy. To do so, wind turbine blades are sized and shaped to rotate in response to the wind. These wind turbine blades are typically large in size, with an extensive surface area, and are therefore prone to defects occurring in manufacture of the blades and during operation. For example, wind turbine blades constructed from composite materials may delaminate by the detachment of the adhesive between the layers of the composite materials over time as a result of a manufacturing defect. Other common blade defects include trailing edge splits, cracks, lightning damage and blade erosion.

Further, wind turbines are generally increasing in size and often being situated near the coast or offshore. With increasing size and harsh operating conditions for wind turbines, monitoring for defects in wind turbine blades is of major importance. The defects reduce the efficiency of operation of the turbines and catastrophic failure of the blades—due to say excessive loading or fatigue damage arising from a defect—can lead to the destruction of the entire wind turbine as well as any adjacent infrastructure. Defects that are detected in their earlier stages are cheaper to repair than defects that are more advanced.

Existing methods of non-destructively detecting defects on wind turbines include having a skilled worker visually inspect for defects at regular intervals using, for example, UAVs or drones, to closely inspect the blades in particular. This method is, however, time consuming, and periodic rather than continuous, and the skilled worker may not detect defects on the surface of the blades as they occur. Further, the skilled worker may not be able to visually detect other defects on the wind turbine, such as in the generator and in other mechanical equipment in the nacelle. Other existing methods include the skilled worker inspecting the blades using portable instruments, such as an instrument for active thermography inspection of the blades or an acoustic measurement device that is mounted to the blades for acoustic inspection of the blades. These portable instruments, however, are required to be set up by the skilled worker at regular intervals and hence may not detect defects in the wind turbines in their early stages in a resource effective manner.

The above discussion of background art is included to explain the context of the present invention. It is not to be taken as an admission that any of the documents or other material referred to was published, known or part of the common general knowledge at the priority date of any one of the claims of this specification.

### SUMMARY OF INVENTION

According to one aspect of the present invention, there is provided an apparatus for detecting anomalies in an acoustic signal, the apparatus including: one or more microphones for receiving an acoustic signal of an environment; and a processor implementing: an acoustic signal processing module configured to: analyse the acoustic signal to identify anomalies in the acoustic signal indicative of events occurring in the environment; and classify the anomalies in the acoustic signal into one or more event classifications; and a communications module configured to output the one or more event classifications, wherein the apparatus is located in the environment and includes an environmental enclosure arranged to house the processor and to protect the processor from environmental contaminants.

According to another aspect of the present invention, there is provided a method of detecting anomalies in an acoustic signal, the method including: locating the above apparatus in an environment; receiving an acoustic signal of the environment; analysing the acoustic signal to identify anomalies in the acoustic signal indicative of events occurring in the environment; classifying the anomalies in the acoustic signal into one or more event classifications; and outputting the one or more event classifications.

Examples of environments include: wind farms, national parks, defence environments, airports, constructions sites, mines and quarries, roads, council areas, factories, work sites, retail sites, major venues, etc. Examples of events include presence of motorbikes in national parks, defects on wind turbines, drone detection at airports, etc. The following table provides some further examples.

| Environment | Event | Further details |
|---|---|---|
| Large, | Motorbikes | Lower cost protection |
| remote and | Wild dogs | Data on animals or incursions into |
| important, | Wildlife protection | park |
| National | (guns) | |
| Parks | Bushfire | |
| | Lighting | |
| | Illegal dumping (truck | |
| | movements) | |
| Defence | Detection and | Defence and security always seeking |
| | surveillance | new ways to detect and defend |
| | | against threats |
| Airports all | Drone detection | Drone is a threat that can shut |
| | Aircraft noise | airports down (noise vs visual). |
| | Remote airport | Remote airports are not manned, |
| | | could provide takeoff and landing |
| | | info. |
| Construction | CBD roads, bridges, | Allow longer operating cycles, |
| in CBDs | buildings | reduce construction periods |
| | | and disturbance |
| Mines and | Mines and quarries | Allow longer mine operating |
| Quarries | located near | cycles |
| adjacent | population | |
| populations | | |
| Councils | Truck compression | Reduce community |
| impacted by | braking noise | complaints, ID and fine |
| freight | Dogs barking | trucks? |
| corridors and | Lawn mowers | |
| other noises | Motorbikes | |
| Asset | Factories and plant | Additional data sensing to |
| intensive | and equipment | predict failure |
| Industry, | | |
| mining, | | |
| energy | | |
| Crowded | Major venues that manage | Community concern and |
| area | large crowds that could be | expectation on government |
| monitoring in | terrorist threat | actions to do all they can to |
| large western | provide sensor based | avoid these threats is high |
| cities under | detection of explosion, gun | When a threat is enacted in a |
| threat from | shots etc that could help | crowded place, it is difficult for |
| terrorist | quantity issue and or | authorities to determine |
| activities | direction of threat | direction quickly, increasing |
| | | risk of more casualties or |
| | | perpetrator escape |

In an embodiment, the environmental enclosure further includes a power supply arranged to supply power to the one or more microphones and the processor. The power supply may be connected to a battery and or solar panels to generate the requisite power. In an embodiment, the apparatus provides continuous, real-time, unattended wind turbine acoustic monitoring. Further, the environmental enclosure is designed to withstand environmental conditions such as rain, snow, extreme heat, dust, salinity, birds, spiders, insects, farm stock and other wildlife.

In an embodiment, the apparatus further includes a microphone housing arranged to at least partially surround the one or more microphones to minimise wind generated noise in the acoustic signal of the environment and to shed contaminants and debris. For example, the microphone housing includes a wind shield and a directivity tube to increase rejection of sound from the general environment, including wind, and selectively measure noise from the wind turbine. The microphone housing designed to shed contaminants and debris and may also be arranged to protect the microphone from ingress of moisture, other environmental contaminants, and or from ingress of insects. The environmental enclosure and the microphone housing thus ensure that monitoring is not adversely influenced by weather, wind generated noise, and external noise sources.

In an embodiment, the one or more microphones include a plurality of spaced apart microphones, and the acoustic signal processing module is further configured to sum the acoustic signal of each of the microphones to form a summed acoustic signal for analysis. The microphones may be spaced apart at less than or equal to a half wavelength of sound at frequencies of the anomalies. The summed acoustic signal here has a reduced noise floor than the acoustic signal due to the spaced apart microphones such that the anomalies in the summed acoustic signal can be identified by the acoustic signal processing module at a lower Sound Pressure Level than in the acoustic signal.

In an example, the summed acoustic signal has a reduction in noise floor over the acoustic signal by approximately a 3dD Sound Pressure Level per doubling of the microphones. Here, the microphones are arranged with the purpose of reducing the noise floor (i.e. quietest measurable noise level) of the apparatus. This is achieved through closely spacing the microphones such that the dimension between the furthest spaced microphones is less than a half wavelength of the sound at frequencies of interest. The sound at these wavelengths arrives coherently or near coherently at all microphones simultaneously, such that the addition of the signal from all microphones results in a 6 dB increase in measured Sound Pressure Level per doubling of number of microphones. At the same time, the self-generated noise (typically from electrical noise, Brownian motion and thermal noise) on the microphones is received incoherently across all the microphones, and so is increased at a rate of 3 dB per doubling of number of microphones. The net result is a 3 dB reduction in noise floor of the apparatus for every doubling of the number of microphones. This allows the apparatus to measure noise from sources which are at a quieter level than would normally be measurable by a system using a single microphone.

In an embodiment, the acoustic signal processing module is further configured to analyse the acoustic signal to identify and remove influence of local environment conditions on the acoustic signal. The acoustic signal processing module is further configured to identify the local environment conditions by selective identification of sound in the acoustic signal that is below a frequency range of the anomalies. The local environment conditions may include at least one of: wind speed and wind direction. For example, the acoustic signal processing module is configured to analyse the acoustic signal and remove influence the wind speed and wind turbine operation on the acoustic signal when analysing to identify anomalies in the acoustic signal

In an embodiment, the apparatus further includes a memory in data communication with the processor, and wherein the acoustic signal processing module is further configured to classify the anomalies in the acoustic signal into the one or more event classifications using a library of acoustic signatures stored on the memory indicative of the event classifications. In addition or in the alternative, the acoustic signal processing module is further configured to classify the anomalies in the acoustic signal into the one or more event classifications using a classifier that was trained using a learning algorithm applied to the library of acoustic signatures.

In the embodiment, the processor is in data communication with the memory to classify the anomalies in the acoustic signal into event classifications and output the event classifications. In another embodiment, the memory and some of the modules of the processor are remote to the microphone(s). That is, for example, the communications module outputs the acoustic signal to an acoustic signal processing module residing on a remote server for analysis.

In the embodiment, the acoustic signal processing module is further configured to analyse the anomalies in the acoustic signal to determine a severity associated with each of the one or more event classifications. The communications module is then further configured to output the severity associated with the one or more event classifications. Further still, the communications module is further configured to output an alert based on the severity associated with the one or more event classifications to a third party device associated with the environment. For example, the severity associated with each of the one or more defect classifications is a ranking from 0 to 10, with 0 to 5 being within the acceptable limits for operation of the wind turbine with a defect and 6 to 10 exceeding the acceptable limits for operation of the wind turbine with the defect. In the embodiment, the communications module outputs the alert when the severity is determined to be within the 6 to 10 range. For example, the alert in the form of an SMS message or an email to a third part device of a maintenance worker is sent when the severity of an identified defect is determined to be within the 6 to 10 range.

In an embodiment, the acoustic signal processing module is further configured to analyse the acoustic signal at designated time intervals. Preferably, the microphone(s) is configured to operate in the frequency range of 20 to 48,000 Hz with, for instance, 10 second long samples of the acoustic signal taken at designated time intervals of, for instance, every 10 minutes.

In an embodiment, the environment includes one or more rotating sources operating in the environment, the acoustic signal of the environment includes sound indicative of operation of the one or more rotating sources, and the events occurring in the environment correspond to defects on the one or more rotating sources. The acoustic signal processing module is further configured to analyse the acoustic signal to identify noise from the rotating sources in the acoustic signal by identifying noise modulated in level and or frequency at a rate matching rotational speed, or multiples (e.g. integer or fractional multiples) of the rotational speed, of the rotating sources.

As mentioned in an above example, the one or more rotating sources includes one or more wind turbines operating in the environment. In an embodiment, the acoustic signal processing module is further configured to analyse the acoustic signal to identify individual blades of a wind turbine in the acoustic signal, and identify anomalies in the acoustic signal indicative of defects on each of the individual blades.

In an embodiment, the acoustic signal processing module is further configured to identify anomalies in the acoustic signal indicative of defects on one of the individual blades of the wind turbine by identifying a change in noise level from said one of the individual blades relative to other blades of the wind turbine.

In an embodiment, the acoustic signal processing module is further configured to identify anomalies in the acoustic signal indicative of defects on the one or more wind turbines by identifying when a level of modulation, at blade pass frequency, of noise in the acoustic signal exceeds a threshold level.

In an embodiment, the acoustic signal processing module is further configured to identify anomalies in the acoustic signal indicative of defects on the one or more wind turbines by identifying a tone in the acoustic signal indicative of the anomalies.

In an embodiment, the acoustic signal processing module is further configured to identify anomalies in the acoustic signal indicative of defects on the one or more wind turbines by identifying an increase in noise spectrum (e.g. root mean square) in the acoustic signal above a threshold level indicative of the anomalies.

In an embodiment, the acoustic signal processing module is further configured to analyse the acoustic signal to identify and remove influence of local environment conditions and normal blade noise on the acoustic signal through selective identification of sound that is modulated in level at a rate matching the rotational speed of the wind turbines.

In an embodiment, the apparatus is located at or in the vicinity of the base of the one or more wind turbines in the environment.

According to another aspect of the present invention, there is provided a system for detecting defects on wind turbines, the system including: a plurality of apparatuses each located adjacent the base of an associated wind turbine, each apparatus including: one or more microphones for receiving an acoustic signal emitted during operation of the associated wind turbine; and a processor implementing: an acoustic signal processing module configured to: analyse the acoustic signal to identify anomalies in the acoustic signal indicative of defects on the associated wind turbine; and classify the anomalies in the acoustic signal into one or more defect classifications on the associated wind turbine; and a communications module configured to output the one or more defect classifications, wherein the apparatuses include an environmental enclosure arranged to house the processor and to protect the processor from environmental contaminants.

Preferably, the system operates by acquiring sound generated by air passing over the moving wind turbine blades, with that sound acquired on/near the ground in the vicinity of the wind turbine. The apparatuses need not be located on or near the plane of the wind turbine rotor, and are not located within one or more of the wind turbine blades. The apparatuses do not use an internal acoustic generator located within the wind turbine blade to detect defects, and do not rely on the Doppler shift of sound from the blades to detect the defects on the blades.

According to another aspect of the present invention, there is provided a method of detecting defects on wind turbines, the method including: locating the above apparatuses adjacent the base of the wind turbines; receiving an acoustic signal emitted during operation of the wind turbines; analysing the acoustic signal to identify anomalies in the acoustic signal indicative of defects on the wind turbines; classifying the anomalies in the acoustic signal into one or more defect classifications on the wind turbines; and outputting the one or more defect classifications. The method and apparatus provide real time, continuous wind turbine monitoring and analysing.

The method and apparatuses thus provide monitoring for detecting defects in their early stages, particularly in the wind turbine blades. As mentioned, wind turbine blade defects are of primary concern; however the wind turbine generator and mechanical equipment in the nacelle are also of concern. In any event, the wind turbines defects are important to address in their early stages as they reduce the overall efficiency of the wind turbine and hence reduce power production, and are generally cheaper to repair in their early stages than defects that are detected in their more advanced stage. Further, in severe cases, these detects if left unattended can cause catastrophic wind turbine failure.

### BRIEF DESCRIPTION OF DRAWINGS

Embodiments of the invention will now be described with reference to the accompanying drawings. It is to be understood that the embodiments are given by way of illustration only and the invention is not limited by this illustration. In the drawings:

FIG. 1 is a representation of an apparatus for detecting anomalies in an acoustic signal according to an embodiment of the present invention;

FIG. 2 is representation of a wind turbine and an apparatus for detecting defects on the wind turbine according to an embodiment of the present invention;

FIG. 3 is a representation of an apparatus for detecting defects on the wind turbine according to an embodiment of the present invention;

FIG. 4 is a representation of a housing of a microphone of the apparatus of FIG. 3; and

FIG. 5 is a flow chart summarising a method of detecting defects on wind turbines according to an embodiment of the present invention.

### DETAILED DESCRIPTION

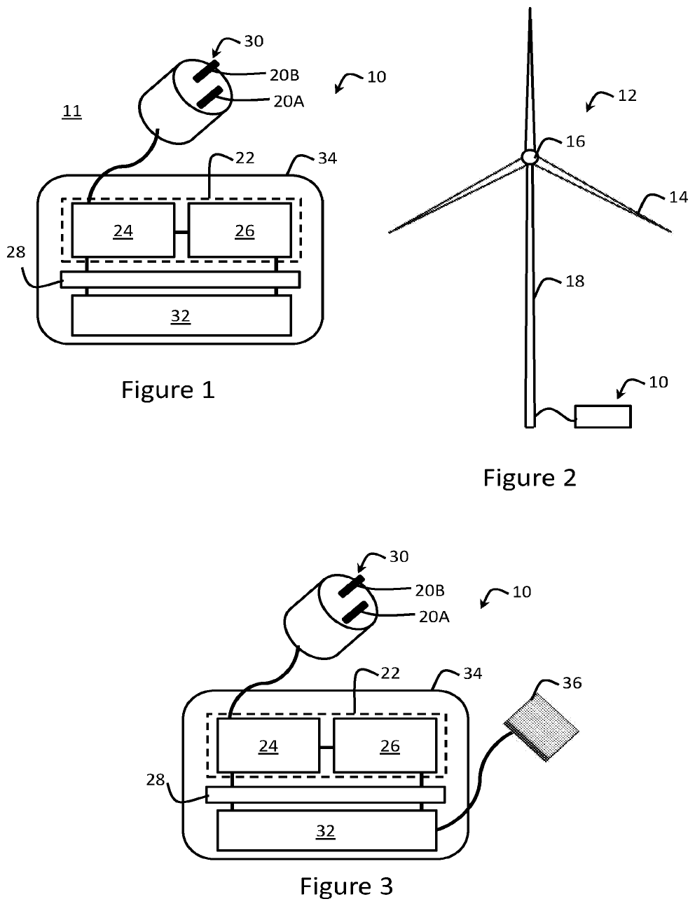

An apparatus 10 for detecting anomalies in an acoustic signal according to an embodiment is shown in FIG. 1. The apparatus 10 includes two microphones 20A 20B for receiving an acoustic signal of an environment 11 and is located in the environment 11. The apparatus further includes a processor 22 implementing a number of modules to analyse the acoustic signal. The modules include an acoustic signal processing module 24 configured to analyse the acoustic signal to identify anomalies in the acoustic signal indicative of events occurring in the environment 11 and to classify the anomalies in the acoustic signal into one or more event classifications, and a communications module 26 configured to output the one or more event classifications. The apparatus 10 includes an environmental enclosure 34 arranged to house the processor 22 and to protect the processor 22 from environmental contaminants.

The apparatus 10 further includes a microphone housing 30 arranged to at least partially surround the two microphones 20A 20B to minimise wind generated noise in the acoustic signal of the environment and to shed contaminants. In other embodiments, each microphones 20A 20B may have its own microphone housing. In any event, the microphone housing 30 is arranged to protect the microphones 20A 20B from ingress of moisture, other environmental contaminants, and/or ingress of insects.

In the embodiment, the microphones 20A 20B are spaced apart, at less than or equal to a half wavelength of sound at frequencies of the anomalies, and the acoustic signal processing module 24 is further configured to sum the acoustic signal of each of the microphones 20A 20B to form a summed acoustic signal for analysis. The summed acoustic signal thus has a reduced noise floor than the acoustic signal due to the two spaced apart microphones 20A 20B such that the anomalies in the summed acoustic signal can be identified by the acoustic signal processing module at a lower Sound Pressure Level than in the acoustic signal. As mentioned, the summed acoustic signal has a reduction in noise floor over the acoustic signal by approximately a 3dD Sound Pressure Level per doubling of the microphones.

Another exemplary embodiment of an apparatus 10 for detecting defects in a wind turbine 12 will now be described with reference to FIGS. 2 and 3. The apparatus 10 for detecting defects on wind turbines is located adjacent the base of an associated wind turbine 12. If the wind turbine 12 is located offshore then the apparatus 10 is located adjacent the tower of the wind turbine but above the waves. As mentioned above, in a system for detecting defects on wind turbines, a plurality of these apparatuses 10 are located adjacent associated wind turbines 12. In the following description, however, a single apparatus 10 with an associated wind turbine 12 will be described.

The wind turbine 12 is a wind turbine normally having three blades 14, a nacelle 16 and a tower 18. It will be appreciated by those persons skilled in the art that the apparatus 10 could be used to detect defects in wind turbines with other configurations and is not limited to three bladed wind turbines. As mentioned, the apparatus 10 provides analysing for detecting defects, particularly in the wind turbine blades 14, but also in the mechanical equipment in the nacelle 16. To do so, the apparatus 10 includes a microphone 20 or number microphones 20A 20B for receiving an acoustic signal emitted during operation of the wind turbine 12 and a processor 22 implementing a number of modules to analyse the acoustic signal. The modules are implemented by software resident on a memory 28 of the apparatus 10.

These modules implemented by the processor 22 include an acoustic signal processing module 24 configured to analyse the acoustic signal received from the microphone 20 to identify anomalies in the acoustic signal indicative of defects on the wind turbine 12. It will be appreciated by those persons skilled in the art that under normal operating conditions, the wind turbine 12 has a relatively stable acoustic signature when removing environmental conditions on the acoustic signal. Accordingly, anomalies in the repetitive acoustic signature matching the rotational speed of the rotor are likely to be the result of defects in the wind turbine 12. Common defects are the result of cracks and splits in the wind turbine blades 14, as well as lightning holes and blade erosion. Other defects are the result of the mechanical equipment housed in the nacelle 16 of the wind turbine 12 failing, such as gearbox or generator damage. Each of these defects has a characteristic acoustic signature that can be used to identify the particular defect that is occurring in the wind turbine 12. Also, some defects are wind speed and direction dependant, and others are related to the nature and size of defect.

Acoustic signatures indicative of defects on the wind turbine 12 are collated and stored in a memory of a computer for training a classifier that is later used by the acoustic signal processing module 24 to classify the anomalies in the acoustic signal into defect classifications. To train the classifier, a skilled worker first annotates or tags the acoustic signatures of the wind turbine defects stored in the memory and a learning algorithm is applied to the annotated acoustic signatures. The classifier is then implemented by the acoustic signal processing module 24 by implementing software code resident in the memory 28 of the apparatus 10 to classify the anomalies in the acoustic signal into the defect classifications. The skilled worker also annotates the acoustic signatures of the wind turbine with a severity rating of the defects (e.g. 1-10). The acoustic signal processing module 24 is thus further configured to analyse the anomalies in the acoustic signal received from the microphones 20A 20B to determine a severity associated with each of the defect classifications.

In addition, the skilled worker annotates the stored audio files of acoustic signatures with wind speed, wind direction and the severity ratings of the defects of the wind turbine blades and the wind turbine mechanical elements. Thus, using a sufficient number of stored samples, the machine learning algorithm is able to categorise the acoustic signal as having defects for a given wind speed and direction and healthy operation of the wind turbine. In addition, new measurements can further be uploaded to the computer with a severity rating to further update the classifier over time.

In another embodiment, these acoustic signatures of anomalies indicative of defects are stored locally on the memory 28. The library of these defect signatures can also be also used for a comparison with measured acoustic signals of the wind turbine 12 by the acoustic signal processing module 24 and the stored defect signatures can be used to determine the severity of the defect and the type of the defect.

The processor 22 further implements a communications module 26 by implementing software code resident in the memory 28 of the apparatus 10 to output the defect classifications. For example, some of the defect classifications of the wind turbine 12 include wind turbine blade crack, blade hole, etc. And the communications module 26 outputs to a third party device associated with maintenance of the wind turbine 12 data in the form of an alert (e.g. SMS) that the wind turbine blade 14 has cracked. The communications module is also configured to receive input data and may communicate with, for example, a keyboard, a mouse, a data receiver, antenna, modem or wireless data adaptor, data acquisition card, etc., to receive data to be stored on the memory 28. The communications module 26 is configured to generate output data to be sent an output device, such as a display device, a set of audio speakers, a printer, a port (for example a USB port), a peripheral component adaptor, a data transmitter or antenna such as a modem or wireless network adaptor, etc.

The communications module 26 is also configured to output an alert based on the severity associated with the defect classifications to a third party device associated with maintenance of the wind turbines. In the example, the communications module 26 outputs an alert in the form of an SMS or email to the third party device when the severity of the defect is determined to be above a threshold level that requires immediate attention by a maintenance worker.

In one embodiment, to more accurately identify the anomalies in the acoustic signal, the acoustic signal processing module 24 is configured to analyse the acoustic signal to identify and remove influence of local environment conditions, such as wind speed and wind direction, on the acoustic signal. It will be appreciated by those persons skilled in the art that the wind speed and direction would have a consist effect on the acoustic signal received from the microphone 20. In addition or in the alternative, the communications module 26 receives data from the turbine 12 of the wind speed and turbine orientation for the acoustic signal processing module 24 to remove the influence of the local environment conditions on the received acoustic signal.

The acoustic signal processing module 24 can also be further configured to identify individual blades 14 of the wind turbine 12 in the acoustic signal, and therefore identify anomalies in the acoustic signal indicative of defects on each of the individual blades once they are suitably annotated by a maintenance worker. That is, each blade 14 may have slightly different dimensions due to uneven wear and manufacturing differences that cause a unique acoustic signature to be generated during operation of the wind turbine 12. Further, the presence of a defect on one of the blades will cause the noise level in the acoustic signal to change repetitively in response to that blade rotating through the air. The acoustic signal processing module 24 can analyse such traits of the acoustic signal in the time and spectral domain to identify the defect in the individual blade and the communications module 26 can output data indicative of the defect on the individual blade 14.

The microphones 20A 20B in the example are configured to operate in the frequency range of 80 to 44,000 Hz with a minimum of 10 second long samples of the acoustic signal taken at designated time intervals. These time intervals may be, for instance, every 10 minutes or every hour, depending on the condition of the wind turbines 12. It will be appreciated by those persons skilled in the art that many defects occur slowly and by acquiring the acoustic signal at designated time intervals, processor and memory resources can be saved without greatly compromising the efficacy of the apparatus 10.

Further, the acoustic signal has a spectra that is recorded every 100 ms and the level of modulation in a number of specific frequency ranges is determined. As mentioned, in one embodiment, the acoustic signal processing module 24 is further configured to identify anomalies in the acoustic signal indicative of defects on the wind turbines by identifying when a level of modulation of noise in the acoustic signal exceeds a threshold level. The modulation is the indication of how much the noise emissions will vary with time (from peak to trough) at the rotational speed of the wind turbine 12.

In another embodiment, the acoustic signal processing module 24 is further configured to identify anomalies in the acoustic signal indicative of defects on the wind turbines by identifying a tone in the acoustic signal indicative of the anomalies. The wind turbine orientation and wind speed data is used to compare periods with the same weather conditions (to predetermined “bins” which relate to a range or wind speeds, e.g. 2 m/s wind speed steps, and a range of directions, e.g. 15 degree steps). The tones generated by a defect are distinguished from the broadband aerodynamic noise of the wind turbine 12 by the acoustic signal processing module 24. The level of tonality of the acoustic signature is then used to establish the presence of a defect. The frequency range of interest and emergence of the tone—i.e. the level above the background—is site specific.

In another embodiment, the acoustic signal processing module 24 is further configured to identify anomalies in the acoustic signal indicative of defects on the one or more wind turbines by identifying an increase in noise spectrum in the acoustic signal above a threshold level indicative of the anomalies. The long term increase in the root mean square noise spectrum is used and compared with previous conditions. An increase above the long term level is used to flag the presence of a defect. The tolerance is determined by site specific testing. The frequency range of interest is also determined by site specific testing or a commissioning phase.

As mentioned, the apparatus 10 is enables provide real time, continuous wind turbine monitoring. As the wind turbine 12 is located in the elements, typically in very exposed areas, the apparatus 10 includes an environmental enclosure 34 arranged to house the processor 26 and the memory 28. Further, to operate the microphones 20A 20B, the processor 26 and the memory 28, the apparatus 10 further includes a power supply 32. The environmental enclosure 34 also houses the power supply 32 which, in the example, is connected to a solar panel to provide continuous power for the apparatus 10. In addition or in the alternative, to provide the continuous power, the apparatus also includes a battery (not shown) connected to the power supply.

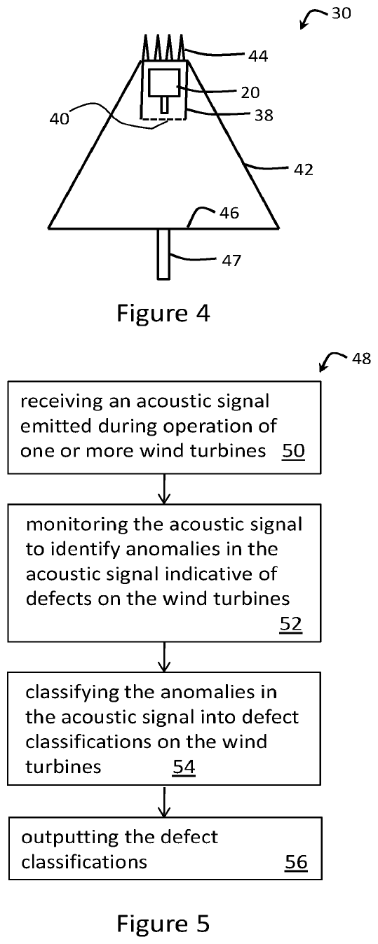

An embodiment of the microphone 20 and its housing 30 is shown in more detail in FIG. 4. The microphone housing 30 is also designed to protect the microphone from the elements by sealing the microphone 20 in a tube housing 38. As mentioned, the microphone housing 30 and the environmental enclosure 34 enable the apparatus 10 to withstand the elements and thus provide real-time, continuous monitoring for defects of the wind turbine 12. It will be appreciated by those persons skilled in the art that wind turbines are typically installed in exposed areas, but with different environmental conditions, such as being exposed to snow, ice, salt water, extreme heat, etc. The microphone housing 30 and the environmental enclosure 34 are therefore arranged to be site specific to account for these different operating conditions.

The tube housing 38 is a directivity tube arranged to increase the rejection of sound from the general environment, such as wind, and to better receive acoustic signals from the wind turbine 12. Further, the microphone housing 30 is arranged to protect the microphone from ingress of moisture, environmental constraints, or insects by the membrane 40 which is acoustically transparent. To further minimise the wind generated noise in the acoustic signal, the microphone housing 30 includes a conical wind shield 42 which is designed to shed contaminants and equally minimise wind generated noise from all directions. Also, the conical wind shield 42 has bird spikes 44 at its top surface to prevent birds from resting on the microphone housing 30 and interfering with the received acoustic signal from the wind turbine 12. Finally, at the bottom surface of the microphone housing 30 is a circular acoustic reflector disc 46, to enhance the acoustic signal, which is connected to a support pole 47 that is typically mounted above the ground closer to the blades 14 of the wind turbine 12, such as 1800 mm above the ground.

Referring now to FIG. 5, there is shown a summary of a flow chart of a method 48 of detecting defects in wind turbines. The method 48 including the steps of: receiving 50 an acoustic signal emitted during operation of one or more wind turbines; analysing 52 the acoustic signal to identify anomalies in the acoustic signal indicative of defects on the one or more wind turbines; classifying 54 the anomalies in the acoustic signal into one or more defect classifications on the wind turbines; and outputting 56 the one or more defect classifications.

In addition, it will be appreciated by those persons skilled in the art that further aspects of the method 48 will be apparent from the above description of the apparatus 10. Further, the persons skilled in the art will also appreciate that at least part of the method 48 could be embodied in software (e.g. program code) that is implemented by the processor 22 configured to control the apparatus 10 for detecting the defects. The software could be supplied in a number of ways, for example of a tangible computer readable medium, such as a disc or a memory, or from a server.

Those skilled in the art will also appreciate that the invention described herein is susceptible to variations and modifications other than those specifically described. It is to be understood that the invention includes all such variations and modifications.

1. An apparatus for detecting anomalies in an acoustic signal, the apparatus including:
one or more microphones for receiving an acoustic signal of an environment; and
a processor implementing:
an acoustic signal processing module configured to:
analyse the acoustic signal to identify anomalies in the acoustic signal indicative of events occurring in the environment; and
classify the anomalies in the acoustic signal into one or more event classifications; and
a communications module configured to output the one or more event classifications,
wherein the apparatus is located in the environment and includes an environmental enclosure arranged to house the processor and to protect the processor from environmental contaminants.

2. An apparatus of claim 1, wherein the environmental enclosure further includes a power supply arranged to supply power to the one or more microphones and the processor.

3. An apparatus of claim 2, further including a microphone housing arranged to at least partially surround the one or more microphones to minimise wind generated noise in the acoustic signal of the environment and to shed contaminants and wherein the microphone housing is arranged to protect the one or more microphones from ingress of moisture, other environmental contaminants, and/or ingress of insects.

4. (canceled)

5. An apparatus of claim 1, wherein the one or more microphones include a plurality of spaced apart microphones, and the acoustic signal processing module is further configured to sum the acoustic signal of each of the microphones to form a summed acoustic signal for analysis.

6. An apparatus of claim 5, wherein the microphones are spaced apart at less than or equal to a half wavelength of sound at frequencies of the anomalies.

7. An apparatus of claim 6, wherein the summed acoustic signal has a reduced noise floor than the acoustic signal due to the spaced apart microphones such that the anomalies in the summed acoustic signal can be identified by the acoustic signal processing module at a lower Sound Pressure Level than in the acoustic signal.

8. An apparatus of claim 7, wherein the summed acoustic signal has a reduction in noise floor over the acoustic signal by approximately a 3dD Sound Pressure Level per doubling of the microphones.

9. An apparatus of claim 1, wherein the acoustic signal processing module is further configured to analyse the acoustic signal to identify and remove influence of local environment conditions on the acoustic signal.

10. An apparatus of claim 9, wherein the acoustic signal processing module is further configured to identify the local environment conditions by selective identification of sound in the acoustic signal that is below a frequency range of the anomalies, wherein the local environment conditions include at least one of: wind speed and wind direction.

11. (canceled)

12. An apparatus of claim 1, wherein the apparatus further includes a memory in data communication with the processor, and wherein the acoustic signal processing module is further configured to classify the anomalies in the acoustic signal into the one or more event classifications using a library of acoustic signatures stored on the memory indicative of the event classifications.

13. An apparatus of claim 12, wherein the acoustic signal processing module is further configured to classify the anomalies in the acoustic signal into the one or more event classifications using a classifier that was trained using a learning algorithm applied to the library of acoustic signatures.

14. An apparatus of claim 12, wherein the acoustic signal processing module is further configured to analyse the anomalies in the acoustic signal to determine a severity associated with each of the one or more event classifications, and the communications module is further configured to output the severity associated with the one or more event classifications and the communications module is further configured to output an alert based on the severity associated with the one or more event classifications to a third party device associated with the environment.

15. (canceled)

16. (canceled)

17. An apparatus of claim 1, wherein the acoustic signal processing module is further configured to analyse the acoustic signal at designated time intervals.

18. An apparatus of claim 1, wherein the environment includes one or more rotating sources operating in the environment, the acoustic signal of the environment includes sound indicative of operation of the one or more rotating sources, and the events occurring in the environment correspond to defects on the one or more rotating sources, and the apparatus is located at or in the vicinity of the base of the one or more rotating sources in the environment.

19. An apparatus of claim 18, wherein the acoustic signal processing module is further configured to analyse the acoustic signal to identify noise from the rotating sources in the acoustic signal by identifying noise modulated in level and or frequency at a rate matching rotational speed, or multiples of the rotational speed, of the rotating sources.

20. An apparatus of claim 18, wherein the one or more rotating sources includes one or more wind turbines operating in the environment.

21. An apparatus of claim 17, wherein the acoustic signal processing module is further configured to analyse the acoustic signal to identify individual blades of a wind turbine in the acoustic signal, and identify anomalies in the acoustic signal indicative of defects on each of the individual blades.

22. An apparatus of claim 21, wherein the acoustic signal processing module is further configured to identify anomalies in the acoustic signal indicative of defects on one of the individual blades of the wind turbine by identifying a change in noise level from said one of the individual blades relative to other blades of the wind turbine.

23. An apparatus of claim 21, wherein the acoustic signal processing module is further configured to identify anomalies in the acoustic signal indicative of defects on the one or more wind turbines by identifying when a level of modulation, at blade pass frequency, of noise in the acoustic signal exceeds a threshold level.

24. An apparatus of claim 23, wherein the acoustic signal processing module is further configured to identify anomalies in the acoustic signal indicative of defects on the one or more wind turbines by identifying a tone in the acoustic signal indicative of
the anomalies; or
the acoustic signal processing module is further configured to identify anomalies in the acoustic signal indicative of defects on the one or more wind turbines by identifying an increase in noise spectrum in the acoustic signal above a threshold level indicative of the anomalies; or
the acoustic signal processing module is further configured to analyse the acoustic signal to identify and remove influence of local environment conditions and normal blade noise on the acoustic signal through selective identification of sound that is modulated in level at a rate matching the rotational speed of the wind turbines.

25. (canceled)

26. (canceled)

27. (canceled)

28. (canceled)

29. (canceled)

30. A method of detecting anomalies in an acoustic signal, the method including:
locating an apparatus of claim 1 in an environment;
receiving an acoustic signal of the environment;
analysing the acoustic signal to identify anomalies in the acoustic signal indicative of events occurring in the environment;
classifying the anomalies in the acoustic signal into one or more event classifications; and
outputting the one or more event classifications.
